(19) United States
(12) Patent Application Publication
(10) Pub. No.: US 2011/0042314 A1
(43) Pub. Date: Feb. 24, 2011

(54) METHOD FOR MAKING PURIFIED WATER AND ELECTRICITY AND A DEVICE THEREFOR

(75) Inventor: Aapo Saask, Stockholm (SE)

Correspondence Address: YOUNG & THOMPSON, 209 Madison Street, Suite 500, Alexandria, VA, 22314, US

(73) Assignee: SCARAB DEVELOPMENT AB, Stockholm (SE)

(21) Appl. No.: 12/667,064

(22) PCT Filed: Jun. 25, 2008
(86) PCT No.: PCT/SE08/50769

§ 371 Date: Oct. 29, 2010

(30) Foreign Application Priority Data
Jul. 2, 2007 (SE) 0701599-3

(51) Int. Cl. C02F 1/14; B01D 61/36

(52) U.S. Cl. 210/640; 210/180

(57) ABSTRACT

A method for producing clean water and electricity, in which water to be cleaned undergoes membrane distillation through one or several units (1) including a first wall (2) that is impermeable to water and has the form of a sheet, a membrane (3) through which water in the gaseous phase can pass, and through which water in fluid phase cannot pass, and a second wall (4) in the form of a sheet. The walls are located on different sides of and at a certain distance from the membrane (3), where water is led in between the first wall (2) and the membrane (3),and where the second wall is caused to be colder than the water. The first wall (2) acts as a solar cell panel (8) with electrically active layers (9) facing away from the membrane, and the solar cell panel is located such that it is illuminated by sunlight.

The present invention relates to a method for producing clean water and electricity and an arrangement for this method.

Many places in the world suffer from a lack of clean water and also a lack of electrical power. Arrangements for cleaning water from contaminants, such as, for example, desalting seawater, are known. Such arrangements often require electricity to function, for powering pumps and control systems, for example.

Such an arrangement is a unit for membrane distillation. Membrane distillation, abbreviated “MD”, has been known for cleaning water since the 1980s. A membrane distillation arrangement is an arrangement that comprises a number of parallel membrane distillation units in the form of sheets. Each unit comprises a first sheet through which water cannot pass, a membrane parallel with the sheet and a second sheet through which water cannot pass parallel with the membrane. Only water in the gaseous phase, i.e. water vapour, can pass through the membrane. Warm water flows between the first sheet and the membrane. The second sheet is colder than the water that is flowing. The difference in temperature between the water and the colder sheet leads to the water being vaporised, passing through the membrane and condensing onto the second, colder wall. The surface tension of the water ensures that the water cannot pass through the membrane. Such a membrane distillation unit is described in the Swedish patent 8002233-8.

Membrane distillation can be used in many fields, such as the desalting of seawater. In this way, all substances, except for clean water, remain in the water that is to be cleaned. The condensed water is thus free from salt, i.e. fresh water.

One problem that arises when membrane distillation is to be used is often a lack of electricity. Many parts of the world that suffer from a lack of fresh water suffer also from a lack of electricity. The climate is often hot, with many sunshine hours.

The present invention concerns a method in which a membrane distillation unit can be used to clean water without access to an external source of electricity.

The present invention thus relates to a method for producing clean water and electricity, where the water that is to be cleaned is caused to undergo membrane distillation by means of one or several units comprising a first wall that is impermeable to water and that has the form of a sheet, a membrane through which water in the gaseous phase can pass, and through which water in fluid phase cannot pass, and a second wall in the form of a sheet, which walls are located on different sides of and at a certain distance from the membrane, where water is led in between the first wall and the membrane and where the second wall is caused to be colder than the water, and it is characterised in that the first wall is caused to be a solar cell panel with the electrically active layers facing away from the membrane and in that the solar cell panel is located such that it is illuminated by sunlight.

Furthermore, the invention relates to an arrangement of the type and with the characteristic features that are specified in claim 5.

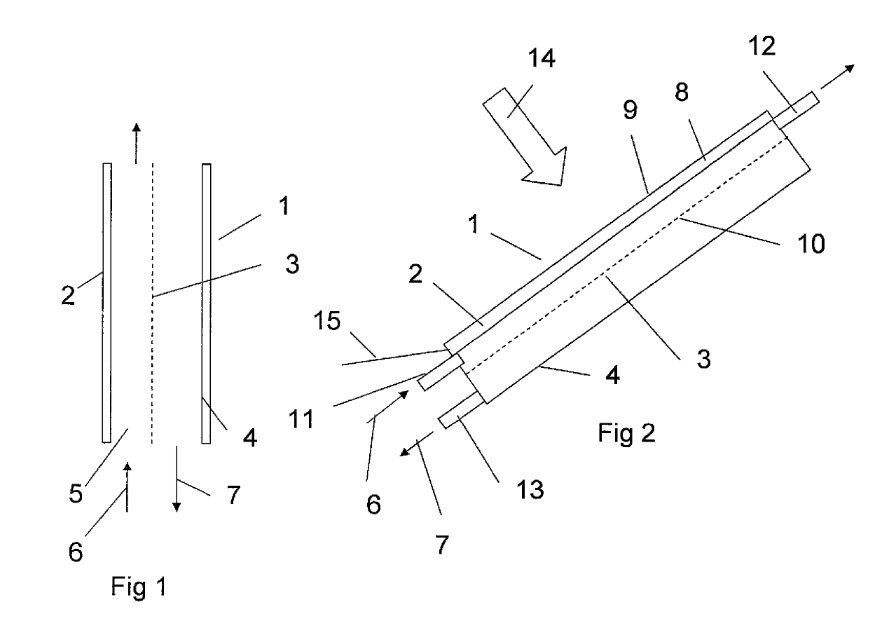

The invention is described in more detail below partially in connection with an embodiment of the invention shown in the attached drawing, where:
FIG. 1 shows schematically a membrane distillation unit according to the prior art
FIG. 2 shows schematically a membrane distillation unit according to the invention.

The principle that is used in the present invention is shown in FIG. 1. The invention concerns a method for producing clean water and electricity. Water that is to be cleaned is caused to undergo membrane distillation by means of one or several membrane distillation units, where each unit 1 comprises a first wall 2 that is impermeable to water and that has the form of a sheet, a membrane 3 through which water in the gaseous phase can pass, and through which water in fluid phase cannot pass, and a second wall 4 in the form of a sheet. The walls 2, 4 are located on different sides of and at a certain distance from the membrane 3. Water is led into the space 5 between the first wall 2 and the membrane 3, as is illustrated by the arrow 6. The second wall 4 is caused to be colder than the water. Since the second wall 4 is colder than the water, water vapour that has passed through the membrane condenses onto the second wall 4 and is transported away as illustrated by the arrow 7.

The second wall 4 can be maintained at a temperature below that of the warmed water by cooling using, for example, unheated seawater, or it may be provided with cooling flanges, or another suitable arrangement.

The first wall 2 is, according to the invention, caused to be a solar cell panel 8 with the electrically active layers facing away from the membrane 3. The solar cell panel is of a suitable known type that generates electrical power when its active surface 9 is illuminated by sunlight. The solar cell panel 8 is located such that it is illuminated by sunlight.

FIG. 2 shows a membrane distillation unit 1 in side view, where a solar cell panel 8 constitutes the first wall 2. The position of the membrane 3 is shown by the dashed line 10. Water is fed into the unit 1 through a pipe 11, which water flows out from the unit through a pipe 12. Condensed water flows out from the unit through a pipe 13. The arrow 14 illustrates the illumination by solar radiation.

Countries in which it is necessary to clean or desalt water normally have many sunshine hours. The solar cell panel 8 generates electricity, which is withdrawn through electrical conductors 15. The solar cell panel 8 becomes warm when the sun shines on it. This heat is led through the panel to the flowing water. The lower surface of the solar panel, and thus the complete solar panel, is in this way cooled. Cooling of solar cell panels increases their efficiency. Thus, the solar cell panel is cooled, which increases its efficiency, while at the same time the temperature of the water increases, which leads to more water vapour passing through the membrane to condense on the second wall 4.

An initial warming of the water before it is led into the membrane distillation unit can take place by means of a solar collector of known type.

It is appropriate if the electrical power that is generated is stored in a battery, not shown, or fed into an existing electrical supply network. The electrical energy that is produced is then used to power a suitable pump, not shown in the drawings, in order to pump the warmed water into the unit and in order to control any valves that may be used to control the flows of water. The electrical energy that is not required for the operation of the membrane distillation unit can be used for various other purposes.

Thus, what is achieved by means of the invention is a method and an arrangement that require solely sun and water in order to produce clean water, such as desalted seawater.

Only a single unit has been described above. Two or more units can be connected in series or in parallel with respect to the flows of water, depending on the capacity desired.

According to one preferred embodiment, the water that is to be cleaned is caused to flow through the said unit or units in a closed circuit, where the closed circuit is caused to be filled with water that is to be cleaned at the same rate as water in the gaseous phase passes through the membrane.

The second wall 4 may be of plastic or metal. The membrane 3 is of a polymer material. Solar cell panels are of suitable known type, constructed, for example, in a glass material on which a number of electrical layers have been applied.

A number of embodiments have been described above. It is, however, obvious that the unit can be given another design, even though its fundamental construction is the one that is described above. For example, a transparent wall may be placed on top of the side of the solar cell panel with active layers, in order to cool also this side of the solar cell panel by means of water.

Thus, the present invention is not be to considered as being limited to the embodiments described above, since it can be varied within the scope defined by the attached patent claims.

1. A method for producing clean water and electricity, in which water that is to be cleaned is caused to undergo membrane distillation by means of one or several units (1) comprising a first wall (2) that is impermeable to water and that has the form of a sheet, a membrane (3) through which water in the gaseous phase can pass, and through which water in fluid phase cannot pass, and a second wall (4) in the form of a sheet, which walls are located on different sides of and at a certain distance from the membrane (3), where water is led in between the first wall (2) and the membrane (3),and where the second wall is caused to be colder than the water, characterised in that the first wall (2) is caused to be a solar cell panel (8) with electrically active layers (9) facing away from the membrane (3), and in that the solar cell panel (8) is located such that it is illuminated by sunlight.

2. A method according to claim 1, characterised in that the water that is to be cleaned is caused to flow through the said unit (1) or units in a closed circuit and in that the closed circuit is caused to be filled with water that is to be cleaned at the same rate as water in the gaseous phase passes through the membrane (3).

3. A method according to claim 1, characterised in that the electricity produced by the solar cell panel (8) is caused to be used to power a required pump that belongs to the arrangement for membrane distillation.

4. A method according to claim 1, characterised in that the electricity produced by the solar cell panel (8) is caused to be used to power a required electrical control circuit and any required valves that belong to the arrangement for membrane distillation.

5. An arrangement for producing clean water and electricity, in which water that is to be cleaned undergoes membrane distillation by means of one or several units comprising a first wall (2) that is impermeable to water and that has the form of a sheet, a membrane (3) through which water in the gaseous phase can pass, and through which water in fluid phase cannot pass, and a second wall (4) in the form of a sheet, which walls are located on different sides of and at a certain distance from the membrane (3), where it is intended that water is to be led in between the first wall (2) and the membrane (3),and where the second wall (4) is arranged such that it is colder than the water, characterised in that the first wall (2) is a solar cell panel (8) arranged to produce electrical power and in that the side of the solar cell panel (8) that has electrically active layers (9) faces away from the membrane (3).

6. A method according to claim 2, characterised in that the electricity produced by the solar cell panel (8) is caused to be used to power a required pump that belongs to the arrangement for membrane distillation.

7. A method according to claim 2, characterised in that the electricity produced by the solar cell panel (8) is caused to be used to power a required electrical control circuit and any required valves that belong to the arrangement for membrane distillation.

8. A method according to claim 3, characterised in that the electricity produced by the solar cell panel (8) is caused to be used to power a required electrical control circuit and any required valves that belong to the arrangement for membrane distillation.

9. A method according to claim 6, characterised in that the electricity produced by the solar cell panel (8) is caused to be used to power a required electrical control circuit and any required valves that belong to the arrangement for membrane distillation.
